(19) United States
(12) Patent Application Publication
(10) Pub. No.: US 2008/0103885 A1
(43) Pub. Date: May 1, 2008

(54) RESOURCE MANAGEMENT

(75) Inventors: Smita Hashim, Saratoga, CA (US); Andrew Szybalski, Mountain View, CA (US); Robert Allen Ryskamp, Menlo Park, CA (US); Scott Bonneau, Ithaca, NY (US); Steve Miller, Menlo Park, CA (US); Graham Hesselroth, Charlottesville, VA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/552,946

(22) Filed: Oct. 25, 2006

(51) Int. Cl. G06Q 30/00

(52) U.S. Cl. 705/14

(57) ABSTRACT

Among other things, receiving a description of an amount of resources from an initiating party; receiving a set of proposals from the initiating party, each proposal having a cost that is less than or equal to the amount of resources, the set having a total cost that is greater than the amount of resources; displaying a selected proposal from the set of proposals to a target party; receiving an acceptance of the selected proposal from the target party; and reducing the amount of resources by an amount equal to the cost of the selected proposal.

Also, identifying a budget, identifying a group of proposals, each proposal having a cost and an associated target party; routing a proposal in the group to the proposal's associated target party; in response to an acceptance of the proposal, reducing the budget by an amount equal to the cost of the proposal.

### TECHNICAL FIELD

This disclosure relates generally to resource management.

### BACKGROUND

Advertising is one way to bring information to the attention of a particular audience. Advertisers typically have limited advertising resources available (i.e., a finite advertising budget), so they may only run a limited number of advertisements in a given time period. To maximize the effectiveness of an advertising campaign, advertisers conventionally attempt to utilize as much of their advertising budget as possible (without exceeding it).

One popular type of advertisement is in media, e.g. printed media such as newspapers and magazines. To advertise in such media, an advertiser can contact the publisher of a selected medium with a proposed advertisement. If the publisher has advertising space available in the printed medium, and the advertiser and publisher can agree on a price and other details of the transaction, then the advertiser can proceed to purchase advertising space and run the advertisement.

Advertisers with large marketing campaigns involving advertisements in several media can contact publishers indirectly using an advertising network. In an advertising network, a publisher may describe a number of advertising spaces available at certain rates, and the advertiser may describe a number of proposed advertisements to be run at certain rates.

### SUMMARY

In general, in one aspect, in any order: receiving a description of an amount of resources from an initiating party; receiving a set of proposals from the initiating party, each proposal having a cost that is less than or equal to the amount of resources, the set having a total cost that is greater than the amount of resources; displaying a selected proposal from the set of proposals to a target party; receiving an acceptance of the selected proposal from the target party; and reducing the amount of resources by an amount equal to the cost of the selected proposal.

Implementations may include one or more of the following features: The initiating party includes an advertiser. The initiating party includes a publisher of media. The proposal includes a description of an advertising space in one or more media. The proposal includes an offer to purchase the advertising space. The proposal includes an offer to sell the advertising space. The one or more media includes a newspaper. The one or more media includes a magazine. Also including determining a likelihood that the proposal will be accepted by the target party. The likelihood is determined using a retail price. Also including determining, prior to reducing the amount of resources, that the cost of the proposal is less than or equal to the amount of resources. Also including removing the selected proposal from the set of proposals; and removing each proposal whose cost exceeds the reduced amount of resources from the set of proposals. Also including repeating steps of: displaying a selected proposal; receiving an acceptance of the selected proposal; reducing the amount of resources removing the selected proposal; and removing each proposal whose cost exceeds the reduced amount of resources until there are no more proposals in the set. The set of proposals is received prior to receiving the acceptance of the selected proposal. The set of proposals includes the printed-media marketing campaign of an advertiser.

In general, in another aspect, identifying a budget, identifying a group of proposals, each proposal having a cost and an associated target party; routing a proposal in the group to the proposal's associated target party; in response to an acceptance of the proposal, reducing the budget by an amount equal to the cost of the proposal.

Implementations may have one or more of the following advantages. Seekers of goods or services, e.g. advertisers seeking to purchase advertising space, can initiate multiple purchasing proposals to multiple suppliers of the goods or services, e.g. publishers with advertising space for sale. The multiple proposals can be specified in a single transaction or communication. If the seeker of goods or services has limited resources, he may nevertheless initiate proposals in excess of his limited resources. For example, an advertiser with a limited advertising budget may initiate multiple proposals, the total value of which exceeds its advertising budget. After a proposal is accepted, the remaining limited resources are monitored, and proposals which are too costly relative to the remaining limited resources are automatically withdrawn. This process can be repeated until all the proposals are either accepted or withdrawn. Proceeding as such allows the seeker of goods or services to utilize all or most of its limited resources to purchase the desired goods or services. For example, proceeding as such allows an advertiser to utilize all or most of its advertising budget.

Other aspects include other combinations of the features recited above and other features, expressed as methods, apparatus, systems, program products, and in other ways. Other features and advantages will be apparent from the description and from the claims.

### DESCRIPTION OF DRAWINGS

FIG. 1A is a schematic representation of a resource management system.

FIG. 1B is a schematic representation of a resource management engine.

FIG. 2A is a schematic representation of an advertiser's pool.

FIG. 2B is a schematic representation of a publisher's pool.

FIG. 3 is a flowchart for monitoring an advertiser's transactions and budget.

FIGS. 4A-D show an evolution of an exemplary advertiser's pool as various proposed advertisements are accepted by various publishers.

FIG. 5 shows an example screenshot seen by an advertiser using the resource management system.

FIG. 6 shows an example screenshot seen by a publisher using the resource management system.

FIG. 7 is a block diagram of a computing device that may be used to implement the resource management system, as either a client or as a server or plurality of servers.

Like reference symbols in the various drawings indicate like elements.

### DETAILED DESCRIPTION

An advertiser is a person, collection of people, or other entity who wishes to make information available to an audience. An advertisement is a vehicle through which the advertiser brings the information to the audience. For example, advertisers can include retailers selling particular products, and an advertisement can include a description of one or more of the products.

A publisher is a person, collection of people, or other entity who makes information available to an audience. A publication is a vehicle through which the publisher makes the information available to the audience. For example, publishers can include newspaper or magazine companies, radio or television stations, film companies, or webmasters. Publications can be embodied in various media, including, e.g., printed media, film, radio, television, or electronic media.

An advertiser can contact a publisher to help the advertiser bring an advertisement to an audience. In some cases, in exchange for a fee, the publisher includes an advertisement in its publication, thereby bringing the advertisement to the publication's audience. Some publishers intentionally format early drafts of their publications so that there is a limited amount of space allocated for advertisements. This space is called advertising space.

Thus, the collection of all advertisers and publishers can be thought of as a market (in an economic sense) in at least one way. In one way, the publishers, as sellers of advertising space, form the supply-side of the market, and the advertisers, as buyers of advertising space, form the demand-side of the market.

Advertising through an advertising network can save an advertiser the effort of individually contacting several publishers directly in order to purchase advertising space. When using some advertising networks, an advertiser may be engaging several publishers simultaneously. Each engagement involves the advertiser describing a proposed advertisement and offering to purchase space in the publisher's media for the proposed advertisement. Since each engagement may result in a purchase of advertising space, the advertiser typically does not simultaneously engage more publishers than the advertiser's budget would accommodate.

However, an engagement may not result in a purchase of advertising space (for example, if a price cannot be agreed on, or if the media does not have sufficient space to accommodate the advertisements, or if the publisher objects to the content of the advertisement). Therefore, for an advertiser to efficiently utilize its entire advertising budget, the advertiser may have to go through several “rounds” of engagements with publishers: in each round, the advertiser attempts to use the portion of its budget that was left over from the previous round due to an unsuccessful engagement. Going through several rounds of engagements can be more time-consuming and burdensome than going through one only round.

The resource management system described below helps an advertiser utilize its budget efficiently in a single round of posting proposed advertisements. As described more fully below, this involves proposing various advertisements to various publishers, and automatically withdrawing those proposals that the advertiser can no longer afford.

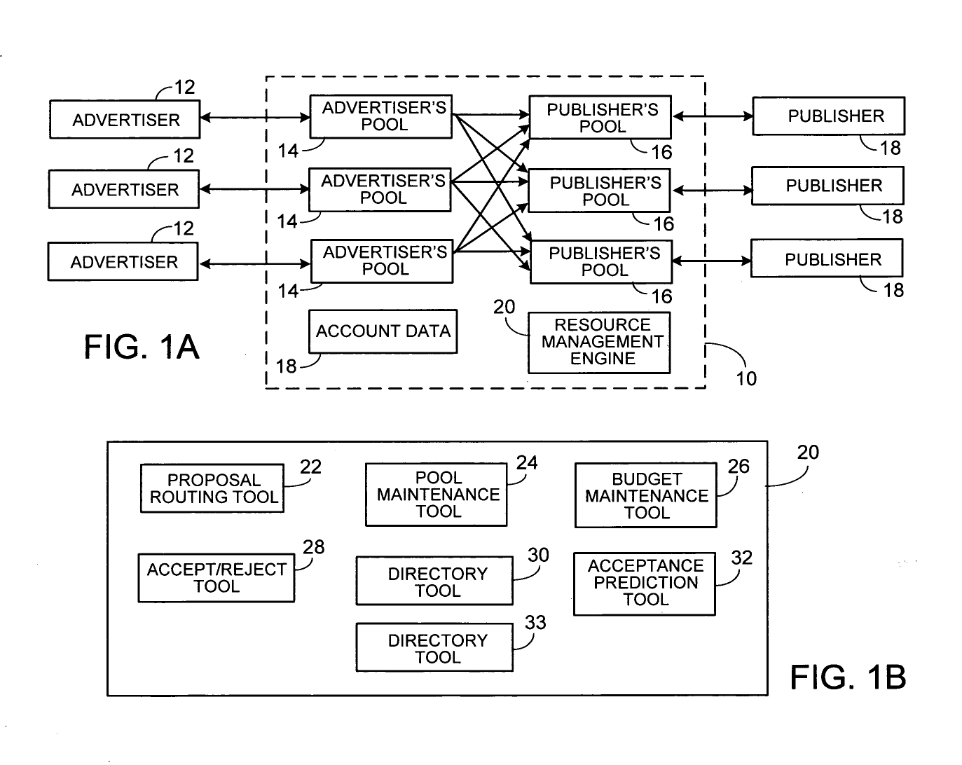

FIG. 1A is a schematic representation of a resource management system 10. The resource management system 10 accommodates one or more (e.g., several) users. In some implementations, the users include one or more (e.g. several) advertisers 12 and one or more (e.g., several) publishers 18.

Each user of the resource management system 10 initially registers with the resource management system 10. In registering, the user provides information which can (but need not) include: a user name, a user type (e.g., advertiser or publisher), contact information (e.g., a business address, a contact phone number, an e-mail address, etc.), a narrative description of the user (e.g., the business an advertiser is in, media produced by a publisher, etc.), and financial information (e.g., a credit card number or bank account number to credit/debit in financial transactions.) Publishers may also include an at least partial description of their publication (e.g., length of publication, available advertising space, sub-sections of the publication if any, etc.) The user-provided information for each user is stored as account data 11.

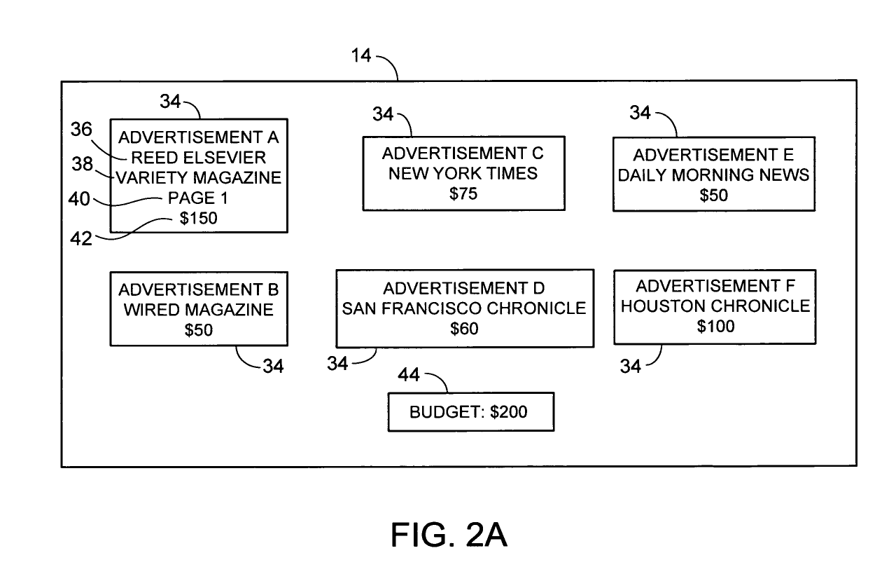

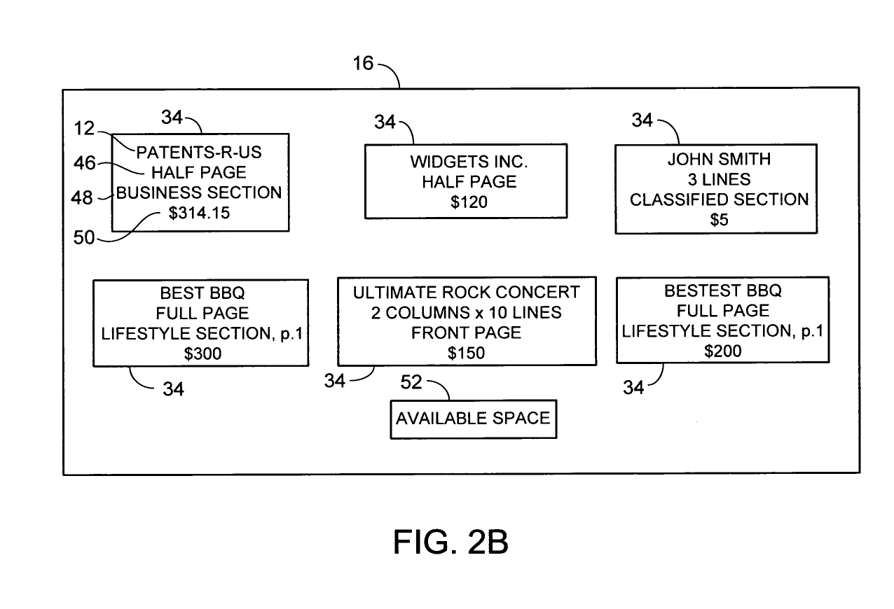

Using the resource management system 10, an advertiser 12 can engage various publishers 18 in order to promote one or more advertiser's marketing campaigns. The advertiser 12 sends proposed advertisements 34 (see FIGS. 2A, 2B) to the resource management system 10, which, in one implementation, are aggregated in pools 14, 16. In one implementation, the proposed advertisements 34 coming from a particular advertiser 12 are aggregated in an advertiser's pool 14 associated with the advertiser 12. Similarly, the proposed advertisements 34 targeting a particular publisher 18 can be aggregated in a publisher's pool 18 associated with the publisher 18.

FIG. 1B shows a schematic representation of an exemplary resource management engine 20. The resource management engine 20 includes a proposal routing tool 22, a pool maintenance tool 24, a budget maintenance tool 26, an accept/reject tool 28, a directory tool 30, an acceptance prediction tool 32, and a communication tool 33.

The proposal routing tool 22 is operable to route a proposed advertisement 34 from a particular advertiser 12 to the proper advertiser's pool 14 and/or publisher's pool 16. In some implementations, the proposal routing tool 22 can inspect each incoming proposed advertisement 34, determine the advertiser 12 and the target publisher 18 based on the information in the proposed advertisement 34, and route the proposed advertisement 34 into the identified advertiser's pool 14 and publisher's pool 16. In some implementations, the proposal routing tool 22 can periodically inspect each advertiser's pool 14, and route any previously-unrouted proposed advertisements 34 to the appropriate target publisher 18.

The pool maintenance tool 24 is operable to add or remove proposed advertisements 34 from the advertisers' pools 14 and publishers' pools 16. For example, if an advertiser's budget can no longer accommodate a proposed advertisement 34, or if a proposed advertisement 34 is accepted by its target publisher 18, or if the advertiser 12 withdraws the proposed advertisement 34, the pool maintenance tool 24 can remove the proposed advertisement from the advertiser's pool 14. Additionally, if a publisher 18 no longer has advertising space to accommodate a proposed advertisement 34, or if the proposed advertisement 34 is withdrawn, the pool maintenance tool 24 can remove the proposed advertisement 34 from the publisher's pool 16.

The budget maintenance tool 26 is operable to monitor or update the advertiser's budget. For example, when a proposed advertisement 34 is accepted by a publisher 18, the budget maintenance tool 26 reduces the advertiser's budget by the cost of the proposed advertisement 34. Additionally, the budget maintenance tool 26 can adjust an advertiser's budget in response to instructions from the advertiser 12. For example, the advertiser 12 may have re-allocated funds in a way that has impacted its advertising budget.

The accept/reject tool 28 is operable to indicate or receive a publisher's acceptance or rejection of a proposed advertisement 34 or a group of proposed advertisements 34. For example, the accept/reject tool 28 can display controls to a publisher (e.g., radio buttons, check boxes, etc.) for accepting or rejecting a proposed advertisement 34 in the publisher's pool 18.

The directory tool 30 is operative to allow information about other users of the resource management system 10 to be located based on a search query. For example, the directory tool 30 can be used to find information about a publisher 18, given the name of the media that it publishes.

The acceptance prediction tool 32 is operable to estimate a likelihood that a given proposed advertisement 34 will be accepted by its target publisher 18. In some implementations, the estimate can be based on the retail price of the advertising space. For example, the acceptance prediction tool 32 can compare the price of the advertisement proposed by the advertiser to the retail price of the advertising space. In some implementations, this comparison can employ a statistical analysis of the past history of the advertiser 12, the publisher 18, or both.

The communication tool 33 is operable to facilitate communication between users of the resource management system 10, or between the resource management system 10 and a user. For example, if a user requests information from the resource management system 10, the communication tool 33 can be used to generate a message containing the information. The communication tool 33 can produce messages in any form, including but not limited to audio messages including computer-generated or pre-recorded sounds, and video messages including e-mail, web pages or portions of web pages, and other text- or graphics-based messages.

FIG. 2A is a schematic representation of an exemplary advertiser's pool 14. In some implementations, each proposed advertisement 34 in the advertiser's pool 14 includes, among other things, a target publisher 36 and/or target media 38 (that is, the media in which the proposed advertisement 34 will be run), a location 40 within the target media where the advertisement is to be run, and the price 42 that the advertiser 12 is willing to pay to run the proposed advertisement 34.

There is no requirement that the total cost of all of the advertisements in the advertising pool 14 (e.g., $485 in FIG. 2A) be less than or equal to the advertiser's budget 44 (e.g., $200 in FIG. 2A). In fact, the total cost of the advertising pool 14 may exceed the advertiser's budget 44 by any amount. To prevent the advertiser 12 from paying for a marketing campaign that exceeds its budget 44, the resource management system 10 monitors the total cost of the accepted advertisements and re-computes the budget 44 remaining each time a proposed advertisement 34 is accepted.

FIG. 2B is a schematic representation of an exemplary publisher's pool 16. The publisher's pool 16 includes the proposed advertisements 34 that target the publisher's media. In one implementation, each proposed advertisement 34 in the publisher's pool 16 includes can include, among other things, a description of the advertiser 12 that proposed each of the various proposed advertisements 34, a description of the size 46 of each proposed advertisement, a price 50 of the proposed advertisement 34, and optionally at least a partial description of a location 48 within the publisher's media that each proposed advertisement 34 will run. If the location within the publisher's media is only partially described, the publisher 18 has discretion to place the proposed advertisement anywhere that satisfies the constraints provided in the partial description.

The size of the proposed advertisement can be (but need not be) specified precisely. For example, the advertiser 12 may include a range of sizes for the proposed advertisement 34 (e.g. “between three and six lines,” or “at least two columns”). Similarly, the location within the publisher's media can be (but need not be) specified precisely. For example, an advertiser 12 may propose an advertisement 34 to be run within any location of a given section of the publisher's media, within any section of a specified page, or within any portion of the publisher's media.

The locations of two or more proposed advertisements 34 in the publisher's pool 16 may overlap within their target media. For example, in FIG. 2B, the proposed advertisements 34 from “Best BBQ” and “Bestest BBQ” overlap: both proposed advertisements 34 are directed to page one of the media's lifestyle section.

When registering with the resource management system 10, the publisher 18 can (but need not) at least partially specify an initial available advertising space 46 in its media. For example, the publisher 18 may specify a total available space, an available space on a section-by-section basis, a total available space on a page-by-page basis, or any other way to describe a portion of media.

If the publisher 18 agrees with the terms and content of the proposed advertisement 34, the proposed advertisement 34 is removed from the advertisement pool 14 and the publisher's pool 16. The publisher 18 can indicate agreement with a proposed advertisement 34 to the resource management system 10 via any communication medium, including but not limited to e-mail or electronic interaction with the advertisement system 10.

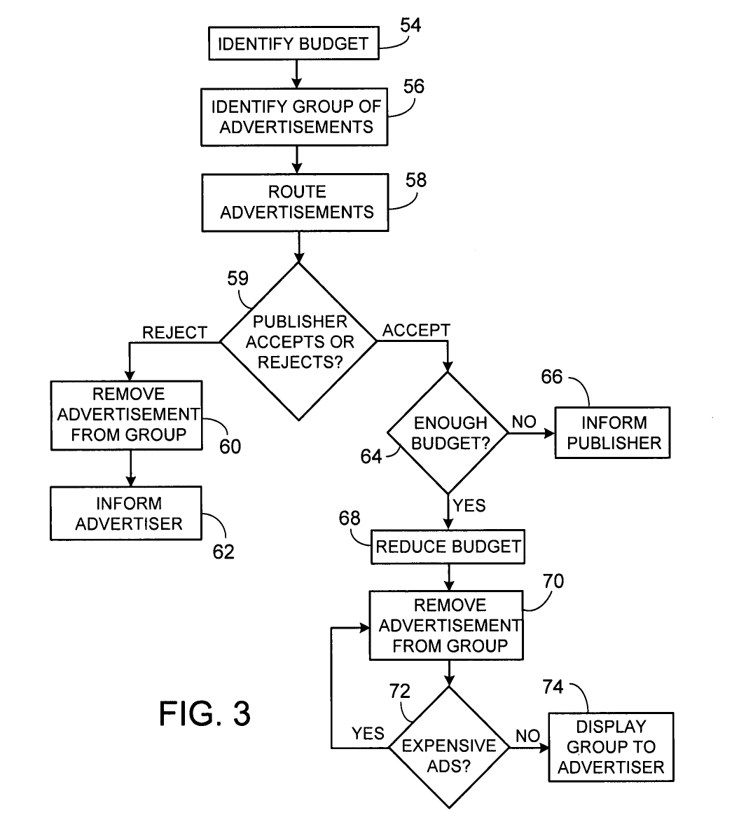

FIG. 3 is a flowchart for monitoring an advertiser's transactions and budget 44. Initially, a budget is identified (step 54). The budget can be provided to the resource management system 10 by an advertiser 12. Next, a group of proposed advertisements are identified (step 56). The group of proposed advertisements can include the proposed advertisements 34 of an advertiser's pool 14. Each proposed advertisement in the group is routed to its respective target publisher (step 58). Routing the proposed advertisements can include replicating a proposed advertisement 34 from an initial location to a publisher's pool 16.

Advertisements are either accepted or rejected (step 59). For example, each publisher 18 either accepts or rejects a given proposed advertisement. Rejected advertisements are removed (step 60) and the advertiser is notified (step 62). If the publisher does not accept the proposed advertisement, then the proposed advertisement is removed from the group of proposed advertisements. For example, the pool maintenance tool 24 can remove the proposed advertisement 34 from the advertiser's pool 14. The advertiser 12 is informed that its proposed advertisement was not accepted. For example, the communication tool 33 can send an electronic communication to the advertiser 12, informing the advertiser 12 of the rejection.

If the publisher 18 accepts the proposed advertisement, then the budget is checked to determine whether the cost of the proposed advertisement exceeds the budget (step 64). For example, the budget can be checked by the budget maintenance tool 26. If the cost of the proposed advertisement exceeds the budget, the publisher is informed that the advertisement has not been accepted (step 66). For example, the communication tool 33 can send the publisher an electronic communication indicating the advertisement has not been accepted. One scenario in which this may occur is where the advertiser's budget has decreased due to other proposals being accepted in the time between the publisher being presented with the proposed advertisement and accepting it.

If the cost of the proposed advertisement does not exceed the budget, then the budget is reduced by the cost of the accepted advertisement (step 68). For example, in the advertiser's pool 14, the budget 44 can be reduced by the price 50 of the proposed advertisement 34, using the budget maintenance tool 26. The proposed advertisement is then removed from the group of advertisements (step 70). For example, the pool maintenance tool 24 can remove the proposed advertisement 34 from the advertiser's pool 14.

The remaining advertisements in the group are then examined to determine whether the cost of any remaining proposed advertisement exceeds the budget (step 72). For example, the budget maintenance tool 26 can cycle through each proposed advertisement 34 in the advertiser's pool 14, and compare the price 50 of each proposed advertisement 34 to the budget 44. Any such proposed advertisements are removed from the group (step 70). For example, the pool maintenance tool 24 can remove such proposed advertisements 34 from the advertiser's pool 14 and/or the target publisher's pool 18.

Note that an advertiser 12 may manually modify its budget 44 for reasons other than having one of its proposed advertisements 34 accepted. For example, the advertiser 12 may decide to re-allocate more or less funds to its budget 44. If the advertiser 12 manually modifies its budget 44, steps 70-72 may be performed to account for the change. In the case where an advertiser 12 has increased its budget 44, previously-proposed advertisements that were removed in a previous iteration of the loop 44-46 may be replaced in the group of advertisements. For example, the pool maintenance tool 24 may replace such advertisements in the advertiser's pool 14.

Eventually, perhaps after repeating steps 70 and 72 a number of times, the advertiser's budget 44 can individually accommodate each proposed advertisement 34 in the group of proposed advertisements. The updated contents of the group of proposed advertisements are displayed to the advertiser, optionally indicating which advertisement or advertisements were accepted by the publisher 18 (step 74). For example, the communication tool 33 can send a message to the advertiser indicating the proposed advertisements 34 remaining in the advertiser's pool.

The above steps describe an interaction of a single advertiser 12 with a single publisher 18. However, the steps can be performed in parallel involving multiple advertisers 12 and publishers 18.

In steps that involve transmitting data to or from the resource management system 10, the data need not be transmitted directly. For example, the data may be transmitted through any number of intermediate parties including but not limited to an internet service provider of the advertiser 12 or the publisher 18, or a third-party system configured to interface with the resource management system 10. Data originating with a party (such as an advertiser 12 or publisher 18) and received by the resource management system 10 is considered to be received “from” the party, regardless of whether the data transmission was direct or indirect. Similarly, data originating with the resource management system 10 that reaches a party is displayed “to” the party, regardless of whether the data transmission was direct or indirect.

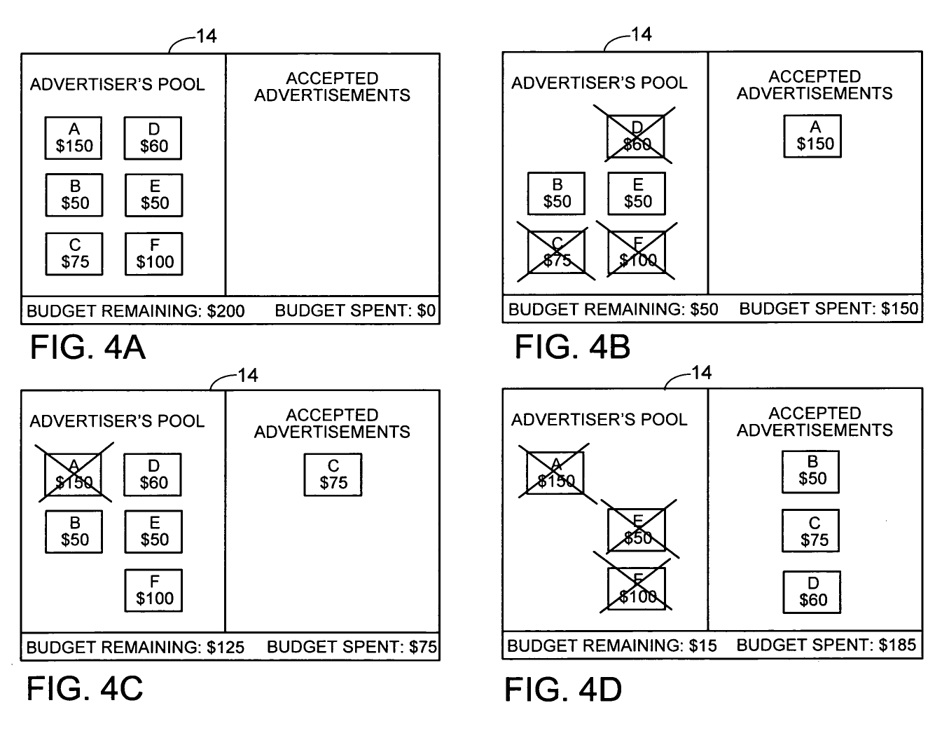

FIGS. 4A-D show an evolution of an exemplary advertiser's pool 14 as various proposed advertisements 34 are accepted by various publishers 18. In this example, suppose the advertiser 12 has a budget 44 of $200, and initially has an advertiser's pool 14 as shown in FIG. 2A, with a total cost of $485. FIG. 4A illustrates an initial condition in which no publisher 18 has accepted any of the proposed advertisements 34.

In FIG. 4B, the publisher 18 corresponding to advertisement A (Variety Magazine, in this example) has accepted the proposed advertisement 34. In accordance with the teachings shown in FIG. 3, the resource management system 10 has removed proposed advertisements D, C, and F from the advertiser's pool 14, leaving advertisements B and E remaining.

Instead, if the publisher 18 corresponding to advertisement C (New York Times, in this example), accepted advertisement C first, as shown in FIG. 4C, then advertisement A would be removed from the advertiser's pool 14. In this example, therefore, the Variety Magazine advertisement would not run. Continuing with this example, if the advertisements B and D were subsequently accepted as shown in FIG. 4D, then the advertiser's pool 14 would be empty, with the advertiser 12 having spent all its budget 44 but $15 on advertising.

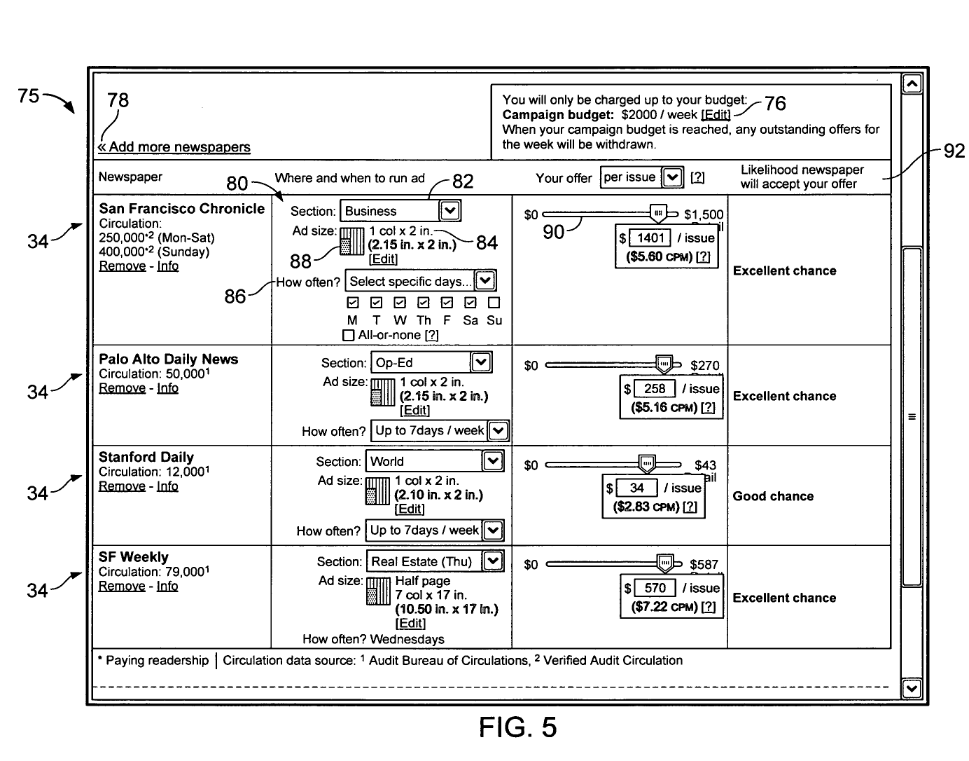

FIG. 5 shows an example screenshot 75 seen by an advertiser 12 using the resource management system 10. The advertiser 12 is presented with a control 76 to modify its budget 44. Using the control 78, the advertiser 12 can add media to its advertiser's pool 14. Proposed advertisements 34 in the advertiser's pool 14 are displayed in rows. Each row includes a description of the media in which the proposed advertisement 34 is to run. In some implementations, this description includes the name and circulation of the media.

Additionally, each row includes controls 80 for modifying the proposed advertisement 34. In some implementations, the controls 80 allow the advertiser 12 to specify the section 82 of the media in which the proposed advertisement 34 is to run, the size 84 of the proposed advertisement 34, and how often it is to run 86. For example, the advertiser 12 can specify the size of the proposed advertisement 34 using a graphical control 88 to indicate the relative dimensions of the media and the proposed advertisement 34, and the advertiser 12 can specify that the proposed advertisement 34 is to run either on specific days, or a specified number of times in an interval (e.g., once a week).

The advertiser 12 can also specify the price of the proposed advertisement 34, for example using a slidebar 90. The low-range of the slidebar 90 is equal to zero, while the high-range is equal to the retail price of the advertising space, as specified by the publisher. The price can be specified or displayed in any form, including but not limited to an absolute dollar-amount, a dollar-amount per issue, or a dollar-amount per thousand publications circulated (“CPM”), etc.

Based in part on the price of the proposed advertisement 34, the resource management system 10 determines a likelihood 92 that the proposed advertisement 34 will be accepted by the publisher 18. For example the acceptance prediction tool 32 can compute the likelihood 92. The likelihood 92 can either be displayed numerically, or qualitatively (“excellent,” “good,” etc.), where the qualitative descriptions are based on numerical ranges (e.g., “excellent” describing a 90%-100% chance, etc.) In some implementations, the likelihood 92 is equal to the ratio of the price of the proposed advertisement 34 to the retail price of the advertising space. In some implementations, the likelihood 92 is computed based on this ratio and other information, such as the historical behavior of the publisher 18 or advertiser 12.

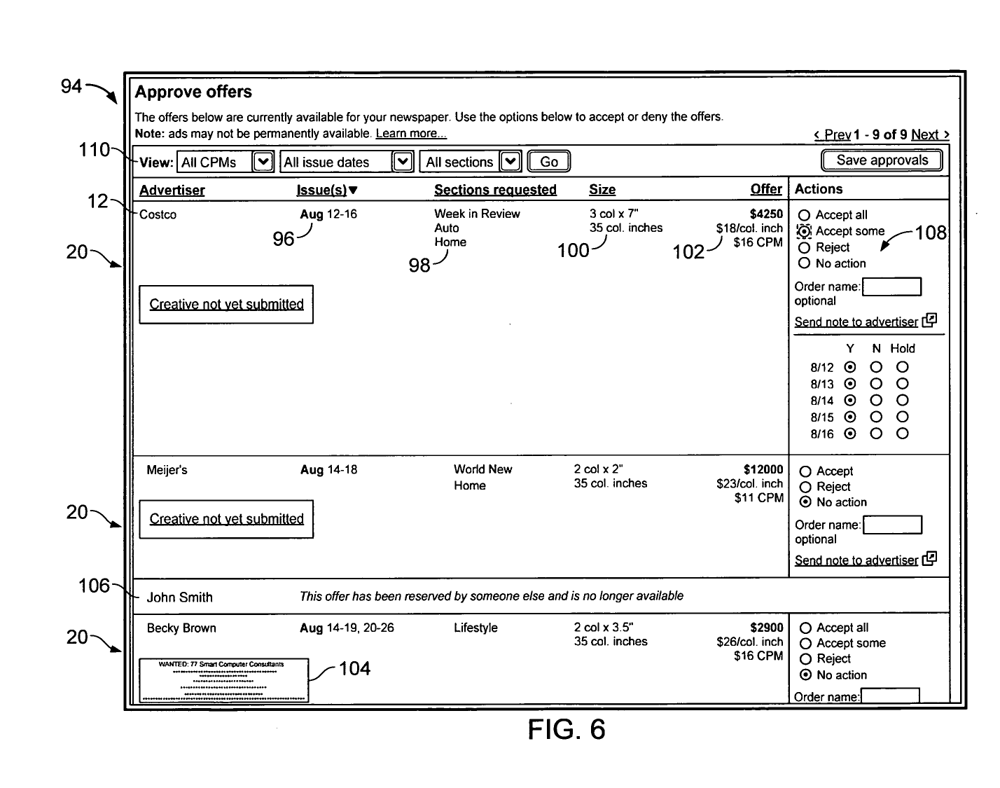

FIG. 6 shows an example screenshot 94 seen by a publisher 18 using the resource management system 10. Proposed advertisements 34 are presented to the publisher 18 in rows, similarly to FIG. 5. In one implementation, each row includes: an identification of the advertiser 12; which issue or issues 96 of the media the proposed advertisement 34 is to run; the requested section or sections 98 of the media in which the proposed advertisement is to run; the size 100 of the proposed advertisement; and the offered price 102 of the proposed advertisement; and the proposed advertisement's creative content 104, if available. Other information is possible including the type of media. The creative content 104 includes any text or images to be displayed in the advertising space.

In addition to the proposed advertisements 34, in some implementations the publisher 18 is also presented with previously-proposed advertisements 106. A previously-proposed advertisement 106 includes any advertisement that was removed from the publisher's pool 16, for example in step 60 in FIG. 3. In some implementations, previously-presented advertisements 106 are displayed to the publisher 18 for a predetermined number of days after they are removed from the publisher's pool 16. In some embodiments, previously-presented advertisements 106 are displayed to the publisher 18 until the publisher 18 clears the previously-presented advertisements 106.

The publisher 18 is presented with controls 108 to accept or reject some or all of the proposed advertisements 34. For example, the controls 108 can be provided by the accept/reject tool 28. In some implementations, the controls 108 also allow the publisher 18 to name each proposed advertisement 34 (for example, for the publisher's accounting purposes). Additionally, in some implementations the controls 108 allow the publisher 18 to send a message to the advertiser 12 prior to accepting or rejecting the proposed advertisement 34. Using this feature, for example, the publisher 18 may inform the advertiser that it requires a higher price for the proposed advertisement 34, or that some modifications should be made to the creative content 104 prior to the proposed advertisement 34 being accepted.

The publisher 18 is also presented with controls 110 that allow it to filter the proposed advertisements 34. In some implementations, the publisher 18 can filter according to days of the week, price of the proposed advertisement, section of the publication, etc.

Although the resource management system 10 has been described in terms of an advertiser 12 proposing an advertisement to a publisher 18, the roles of the advertiser 12 and the publisher 18 can be (but need not be) reversed, or both roles can (but need not) proceed at the same time. That is, either the advertiser 12 or the publisher 18 can initiate an engagement of the other party. In the case of an advertiser 12 as the initiating party, as described above, the proposal concerns an advertisement, and the budget 44 concerns a limited amount of money for advertising. In the case of a publisher 18 as the initiating party, the proposal concerns advertising space in one or more media, and the budget concerns limited amount of available space 52 for advertising. In the case of a publisher 18 as the initiating party, the resource management system 10 treats the publisher's proposal similarly to a proposed advertisement 34; i.e., the proposal is placed in the publisher's pool, is replicated to a corresponding advertiser's pool, etc.

Indeed, the use of the resource management system 10 need not be limited to advertising-related transactions between advertisers and publishers. The resource management system 10 can be used to help any party or group of parties with limited resources (e.g., a budget or limited advertising space) efficiently use the limited resources to transact for goods or services with another group of parties in a position to supply the goods or services. That is, the resource management system 10 can be employed in any economic market, or several economic markets simultaneously. The parties in the demand-side of a market can act as initiating parties (e.g., in the role of advertisers as described above), and the parties in the supply-side of a market can act as target parties.

For example, service providers (including but not limited to decorators, construction workers, contractors, fitness trainers, etc.) can use the resource management system 10 to engage potential clients for work. In this case, the service provider's limited resources may include the limited time during a day that the service provider has allocated for work. For example, suppose a service provider has allocated the hours between 9:00 am and 5:00 pm for work. Using the resource management system 10, the service provider may propose a first engagement to a potential client to take place during the hours of 9:00 am and 2:00 pm, and a second engagement to another potential client to take place during the hours of 12:00 pm to 5:00 pm. Insofar as these proposals overlap in time, their total “cost” exceeds the service provider's time budget. Thus, the resource management system 10 can withdraw one proposal when the other is accepted.

The word “cost” is not meant to be limited to monetary terms. In general, when a party has a limited amount of a type of resources, the “cost” of a proposal is measured in terms of the limited resources. Thus, for advertisers 12 with limited monetary resources, the “cost” of a proposal refers to its monetary value; for publishers 18 with limited space, the “cost” of a proposal refers to the spatial dimensions of the proposed advertising space, for service providers with limited time, the “cost” of a proposal refers to the time allotted for the proposed services, etc.

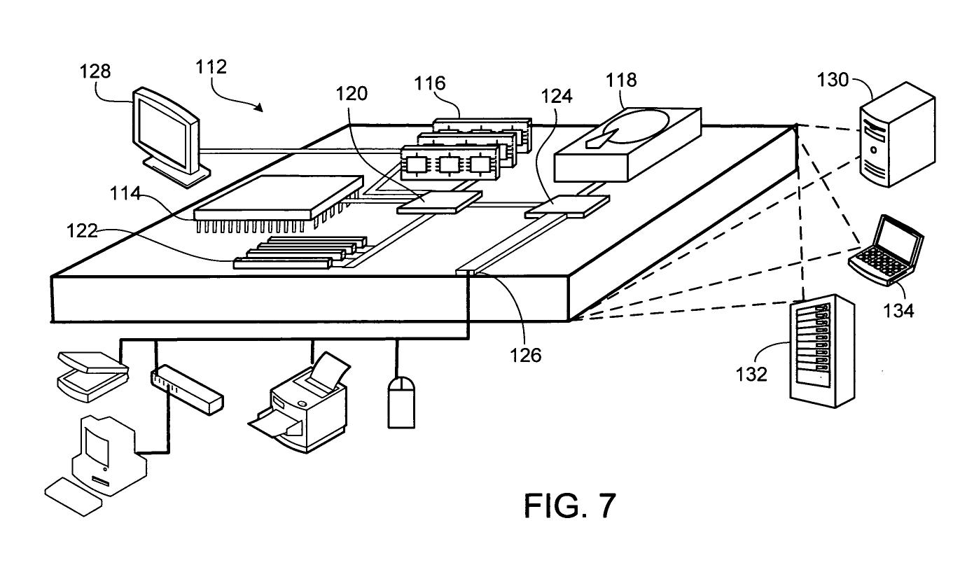

FIG. 7 is a block diagram of a computing device 112 that may be used to implement the resource management system 10, as either a client or as a server or plurality of servers. Computing device 112 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 112 includes a processor 114, memory 116, a storage device 118, a high-speed interface 120 connecting to memory 116 and high-speed expansion ports 122, and a low speed interface 124 connecting to low speed bus 126 and storage device 118. Each of the components 114, 116, 118, 120, 122, and 124, are interconnected using various busses, and may be mounted on a common motherboard or in other manners as appropriate. The processor 114 can process instructions for execution within the computing device 112, including but not limited to instructions stored in the memory 116 or on the storage device 118 to display graphical information for a GUI on an external input/output device, such as display 128 coupled to high speed interface 120. In other implementations, multiple processors and/or multiple buses may be used, as appropriate, along with multiple memories and types of memory. Also, multiple computing devices 112 may be connected, with each device providing portions of the necessary operations (e.g., as a server bank, a group of blade servers, or a multi-processor system).

The memory 116 stores information within the computing device 112. In one implementation, the memory 116 is a computer-readable medium. In one implementation, the memory 116 is a volatile memory unit or units. In another implementation, the memory 116 is a non-volatile memory unit or units.

The storage device 118 is capable of providing mass storage for the computing device 112. In one implementation, the storage device 118 is a computer-readable medium. In various different implementations, the storage device 118 may be a floppy disk device, a hard disk device, an optical disk device, or a tape device, a flash memory or other similar solid state memory device, or an array of devices, including but not limited to devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 116, the storage device 118, memory on processor 114, or a propagated signal.

The high speed interface 120 manages bandwidth-intensive operations for the computing device 112, while the low speed interface 126 manages lower bandwidth-intensive operations. Such allocation of duties is exemplary only. In one implementation, the high-speed interface 120 is coupled to memory 116, display 128 (e.g., through a graphics processor or accelerator), and to high-speed expansion ports 122, which may accept various expansion cards (not shown). In the implementation, low-speed interface 126 is coupled to storage device 118 and low-speed expansion port 124. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 112 may be implemented in a number of different forms, as shown in the figure. For example, it may be implemented as a standard server 130, or multiple times in a group of such servers. It may also be implemented as part of a rack server system 132. In addition, it may be implemented in a personal computer such as a laptop computer 134.

Various implementations of the resource management system 10 can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including but not limited to at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including but not limited to a machine-readable medium that receives machine instructions as a machine-readable signal. The term “machine-readable signal” refers to any signal used to provide machine instructions and/or data to a programmable processor.

To provide for interaction with a user, the resource management system 10 can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including but not limited to acoustic, speech, or tactile input.

The resource management system 10 can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the resource management system 10), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other embodiments are within the scope of the following claims.

What is claimed is:

1. A computer-implemented method comprising, in any order:
receiving a description of an amount of resources from an initiating party;
receiving a set of proposals from the initiating party, each proposal having a cost that is less than or equal to the amount of resources, the set having a total cost that is greater than the amount of resources;
displaying a selected proposal from the set of proposals to a target party;
receiving an acceptance of the selected proposal from the target party; and
reducing the amount of resources by an amount equal to the cost of the selected proposal.

2. The method of claim 1, wherein the initiating party includes an advertiser.

3. The method of claim 1, wherein the initiating party includes a publisher of media.

4. The method of claim 1, wherein the set of proposals includes a description of an advertising space in one or more media.

5. The method of claim 4, wherein the set of proposals includes an offer to purchase the advertising space.

6. The method of claim 4, wherein the set of proposals includes an offer to sell the advertising space.

7. The method of claim 4, wherein the one or more media includes a newspaper.

8. The method of claim 4, wherein the one or more media includes a magazine.

9. The method of claim 1, further comprising:
determining a likelihood that the proposal will be accepted by the target party.

10. The method of claim 9, wherein the likelihood is determined using a retail price.

11. The method of claim 1, further comprising determining, prior to reducing the amount of resources, that the cost of the proposal is less than or equal to the amount of resources.

12. The method of claim 1, further comprising:
removing the selected proposal from the set of proposals; and
removing each proposal whose cost exceeds the reduced amount of resources from the set of proposals.

13. The method of claim 12, further comprising repeating steps of:
displaying a selected proposal;
receiving an acceptance of the selected proposal;
reducing the amount of resources;
removing the selected proposal; and
removing each proposal whose cost exceeds the reduced amount of resources until there are no more proposals in the set.

14. The method of claim 1, wherein the set of proposals is received prior to receiving the acceptance of the selected proposal.

15. The method of claim 1, wherein the set of proposals includes a printed-media marketing campaign of an advertiser.

16. A method comprising
identifying a budget;
identifying a group of proposals, each proposal having a cost and an associated target party;
routing a proposal in the group to the proposal's associated target party;
in response to an acceptance of the proposal, reducing the budget by an amount equal to the cost of the proposal.

17. A system comprising:
means for receiving a budget;
means for receiving a set of proposals from an initiating party, each proposal having a cost that is less than or equal to the budget, the set of proposals having a total cost that is greater than the budget;
means for presenting a selected proposal from the set of proposals to a target party;
means for receiving an acceptance of the selected proposal from the target party;
means for reducing the budget by an amount equal to the cost of the selected proposal.

18. The system of claim 17, wherein the initiating party includes an advertiser.

19. The system of claim 17, wherein the initiating party includes a publisher of media.

20. The system of claim 17, wherein the set of proposals includes a description of an advertising space in one or more media.

21. The system of claim 20, wherein the set of proposals includes an offer to purchase the advertising space.

22. The system of claim 20, wherein the set of proposals includes an offer to sell the advertising space.

23. The system of claim 20, wherein the one or more media includes a newspaper.

24. The system of claim 20, wherein the one or more media includes a magazine.

25. The system of claim 17, further comprising: means for determining a likelihood that the proposal will be accepted by the target party.

26. The system of claim 25, wherein the likelihood is determined using a retail price.

27. The system of claim 17, further comprising means for determining, prior to reducing the amount of resources, that the cost of the proposal is less than or equal to the amount of the resources.

28. The system of claim 17, further comprising:
means for removing the selected proposal from the set of proposals; and
means for removing each proposal whose cost exceeds the reduced amount of resources from the set of proposals.

29. The system of claim 28, further comprising:
a display;
means for receiving an acceptance of the selected proposal;
means for reducing the amount of resources;
means for removing the selected proposal; and
means for removing each proposal whose cost exceeds the reduced amount of resources, until there are no more proposals in the set.

30. The system of claim 17, wherein the means for receiving the set of proposals is configured to receive the set of proposals prior to the system receiving the acceptance of the selected proposal.

31. The system of claim 17, wherein the set of proposals includes a printed-media marketing campaign of an advertiser.

32. A computer-readable medium bearing instructions that, when executed, cause a computer to:
receive a description of an amount of resources from an initiating party;
receive a set of proposals from the initiating party, each proposal having a cost that is less than or equal to the amount of resources, the set having a total cost that is greater than the amount of resources;
display a selected proposal from the set of proposals to a target party;
receive an acceptance of the selected proposal from the target party;
reduce the amount of resources by an amount equal to the cost of the selected proposal.

33. The computer-readable medium of claim 1, wherein the initiating party includes an advertiser.

34. The computer-readable medium of claim 32, wherein the initiating party includes a publisher of media.

35. The computer-readable medium of claim 32, wherein the set of proposals includes a description of an advertising space in one or more media.

36. The computer-readable medium of claim 35, wherein the set of proposals includes an offer to purchase the advertising space.

37. The computer-readable medium of claim 37, wherein the set of proposals includes an offer to sell the advertising space.

38. The computer-readable medium of claim 32, wherein the one or more media includes a newspaper.

39. The computer-readable medium of claim 32, wherein the one or more media includes a magazine.

40. The computer-readable medium of claim 32, wherein the instructions further cause the computer to determine a likelihood that the proposal will be accepted by the target party.

41. The computer-readable medium of claim 40, wherein the likelihood is determined using a retail price.

42. The computer-readable medium of claim 32, wherein the instructions further cause the computer to determine, prior to reducing the amount of resources, that the cost of the proposal is less than or equal to the amount of resources.

43. The computer-readable medium of claim 32, wherein the instructions further cause the computer to:
remove the selected proposal from the set of proposals; and
remove each proposal whose cost exceeds the reduced amount of resources from the set of proposals.

44. The computer-readable medium of claim 43, wherein the instructions further cause the computer to repeat the actions of:
displaying a selected proposal;
receiving an acceptance of the selected proposal;
reducing the amount of resources;
removing the selected proposal; and
removing each proposal whose cost exceeds the reduced amount of resources until there are no more proposals in the set.

45. The computer-readable medium of claim 32, wherein the instructions cause the computer to receive the set of proposals prior to receiving the acceptance of the selected proposal.

46. The computer-readable medium of claim 32, wherein the set of proposals includes a printed-media marketing campaign of an advertiser.
